(19) United States
(12) Patent Application Publication
(10) Pub. No.: US 2009/0095183 A1
(43) Pub. Date: Apr. 16, 2009

(54) Printing plates with permanent resin laminated interleaf

(76) Inventor: Howard A. Fromson, Stonington, CT (US)

Correspondence Address: ALIX YALE & RISTAS LLP, 750 MAIN STREET, SUITE 1400, HARTFORD, CT, 06103, US

(21) Appl. No.: 11/975,074

(22) Filed: Oct. 16, 2007

(51) Int. Cl. B41N 1/08; B41N 3/00

(52) U.S. Cl. 101/457; 101/463.1

(57) ABSTRACT

In a lithographic printing plate and method of manufacture, an interleaf is permanently integrated to the bottom surface of the plate substrate. A thin, flexible, water and solvent insoluble film is adhered to and covers the bottom surface of the coated and cured sheet before the sheet is cut into plates. The interleaf has a lesser thickness than the thickness of the substrate. A preferred method comprises the steps of selecting a wound coil of aluminum sheet, unwinding the coil and advancing the sheet through a coating station at which a liquid coating of radiation imageable material is applied to the top surface of the sheet, curing the material to form a cured coating adhered to the top surface of the sheet, laminating a polymeric film to the bottom surface of the sheet, and advancing the laminated sheet to a cutting device where individual plates are cut from the sheet.

### BACKGROUND

The present invention relates to lithographic printing, and particularly to the manufacture of imageable plates that are stacked with interleaving to protect the imageable coating.

Modern lithographic printing plates, especially for the newspaper and commercial printing industries, are typically manufactured by coating a substantially continuous sheet of metal substrate material with a liquid resin, curing the resin, cutting the coated and cured sheet into rectangles having the desired end product dimensions, optionally punching to create alignment holes, and then stacking and bundling the plates for shipment to the imaging and printing facility. To protect the coating and facilitate removal of individual plates from the stack, an interleaf is provided between successive plates on the stack. Commonly, such interleaving consists of loose polymer coated papers having substantially the same rectangular dimension as the plates.

The plates must be removed from the stack and individually imaged, such as by an infrared, violet, or ultraviolet laser, depending on the radiation sensitivity characteristics of the coating. Each imaged plate is then developed in a bath of alkaline developer solution or solvent, depending on the coating. Regardless of the radiation sensitivity or type of developer bath, the interleaf must be removed before the plate is imaged or subjected to the developer.

The present inventor has recognized that such conventional manufacture and use of the plates includes at least two wasteful steps. The first is the insertion of interleaves between the plates during stacking, and the second is the removal of the interleaves before imaging or developing.

### SUMMARY

It is an object of the invention to eliminate the loose interleaf in the manufacture and use of lithographic printing plates.

This object is achieved by providing an interleaf that is permanently integrated to the bottom surface of the plate substrate.

In general, a thin, flexible, water and solvent insoluble film is adhered to and covers the bottom surface of the elongated sheet before the sheet is cut into plates. The interleaf has a lesser thickness than the thickness of the substrate.

A preferred method comprises the steps of selecting a wound coil of aluminum sheet, unwinding the coil and advancing the sheet through a coating station at which a liquid coating of radiation imageable material is applied to the top surface of the sheet, curing the material to form a cured coating adhered to the top surface of the sheet, laminating a polymeric film to the bottom surface of the sheet, and advancing the laminated sheet to a cutting device where individual plates are cut from the sheet.

Preferably, after lamination, the sheet is rewound into a coil, whereby in the windings of the recoil, the polymeric film is interposed between the coating on the top surface of a given winding and the bottom surface of the next winding, and the coil is unwound and the unwound sheet advanced to a cutting device and/or slitter.

The film is preferably a polyolefin material laminated to the substrate by heat.

The plate embodiment preferably comprises a metal substrate having top and bottom surfaces, a radiation imageable coating covering and adhered to the top surface of the substrate, and a polymeric film adhered to the bottom surface of the substrate, wherein the interleaf has a lesser thickness than the thickness of the substrate.

The polymeric film is preferably a polyolefin laminated to the bottom surface of the substrate, at a thickness in the range of about 0.5-2.0 mils.

The interleaving technique disclosed herein, provides several significant advantages.

The interleaf film can be applied automatically and continuously without human intervention to the sheet of material during manufacture, without limiting the rate of throughput.

When the interleaf film is applied before cutting of the sheet, the film provides lubrication for the knife blades. This is especially important when plates are stacked for trimming to a non-standard size, via guillotine blades. This self-lubrication avoids the need for either a lubrication additive or the slowing down of the cutting rate to assure that excessive friction heat does not build up and fuse the plates against the knife edge.

In manufacturing lines where the coated sheet is recoiled and relocated to a cutting station, the integrated interleaf applied after curing of the coating protects the coating on the sheet during such recoiling and subsequent uncoiling at the cutting station.

The integrated interleaf permits the rapid stacking of cut plates without the intervening step of inserting a loose interleaf, and without the risk that an interleaf may have been inadvertently omitted or inserted incorrectly so as to render a portion of the underlying plate unprotected. The protection provided by the integrated interleaf remains active during stacking, handling and shipping of the bundle, and during unbundling and handling of the plates before feeding of the individual plates to the imager.

The plates can be directly fed to the imager, thereby avoiding the need for the commonly used interleaf removal device. The integrated interleaf is non-removable, i.e., it does not come loose, dissolve, or otherwise disintegrate during the imaging or in the developer solution and associated rollers, washers, and dryers.

The interleaf remains intact when the imaged plates are restacked or otherwise gathered for attachment to the printing press cylinder. The thin, flexible interleaf film can bend with the curvature of the plate when attached to the cylinder. For example, a typical newspaper plate is about 12.5×22 inches and several such plates are attached to a printing press cylinder having a diameter of about 18 inches.

Although the film is flexible, it is preferably of sufficient density and thickness (0.5-2.0 mils) that the thickness of the metal substrate (8-12 mils) can be reduced a similar amount, thereby preserving the overall developed plate thickness required in the printing press (about 8-12 mils), while saving on the high cost of substrate material.

### BRIEF DESCRIPTION OF THE DRAWING

A representative embodiment will be described below with reference to the accompanying drawing, in which:

FIG. 1 is a schematic of a manufacturing line for lithographic printing plates, including a station for applying the integrated interleaf to the bottom of a coated and cured continuous sheet and then recoiling the sheet, according to one embodiment of the invention;

FIG. 2 is a schematic of a continuation of the manufacturing line of FIG. 1, wherein the recoiled sheet is uncoiled and advanced through a cutting station, and the cut plates stacked for shipment or trimming to a smaller size;

FIG. 3 is a plan view of the top side of the sheet of FIG. 2, with dashed lines showing where the knife blades cut the sheet into individual plates of standard size;

FIG. 4 is a section view of the sheet of FIG. 3, showing the integrated interleaf on the bottom of the substrate; and

FIG. 5 is a detailed view of a plurality of stacked plates ready for shipment or trimming, showing the integrated interleaf of an upper plate protecting the coating of the adjacent lower plate.

### DETAILED DESCRIPTION

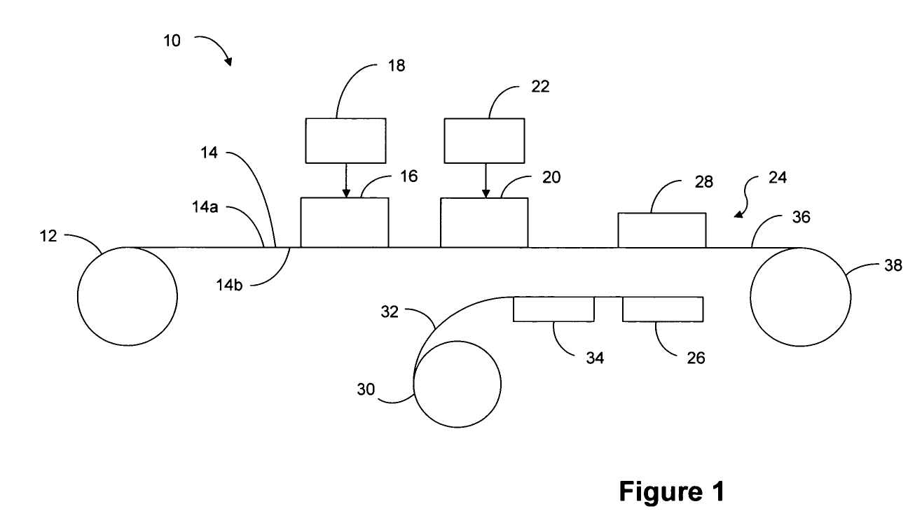

In FIG. 1, the coating line 10 of a plate manufacturing plant includes a feed coil 12 of thin aluminum sheet material 14 that is continuously unwound such that the grained and anodized surface 14a is on top and the untreated surface 14b is on the bottom. The top surface 14a is uniformly coated at 16 from a source 18 of liquid composition containing radiation sensitive and other compounds (as is well known in the art), and the liquid is cured at 20 with heat supplied at 22 until the coating adheres to the substrate and exhibits sufficient cohesion to maintain its integrity when the sheet is later recoiled, cut, and the resulting plates are handled and imaged.

According to the present disclosure, an interleaf adhesion station 24 is situated between the curing at 20 and the recoiling at 38. Preferably, the sheet carrying the cured coating passes between heated roll 26 and an opposed roll 28, whereby a thin, flexible film 32 from film supply 30 is laminated to the entire bottom surface of the sheet in a continuous operation. This process may include a device 34 for guiding and/or feeding the continuous sheet of film from source 30, to the roll 26.

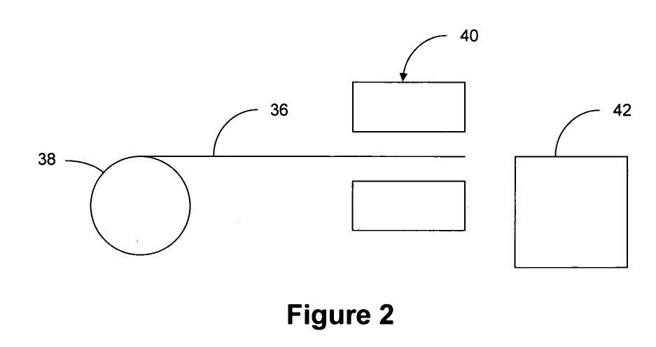

The resulting sheet at 36 consists essentially of a metal substrate, a cured radiation sensitive coating adhered to the top side of the substrate, and a thin, flexible film adhered to the bottom side of the substrate. The sheet may optionally receive a top coat of, for example, PVOH, as a barrier to the penetration of oxygen during shipment and storage. The sheet at 36 may be immediately cut into individual plates, but typically the sheet is recoiled at 38 and moved to a cutting line as represented in FIG. 2.

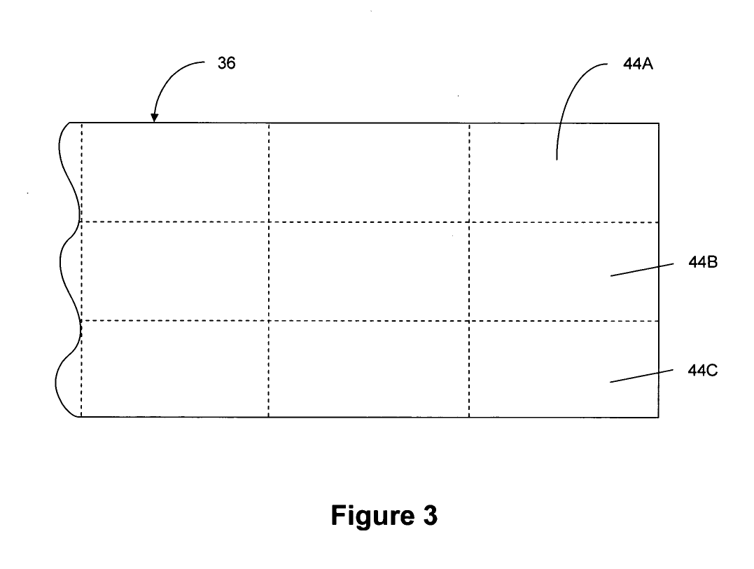

In FIG. 2, the sheet 36 is advanced to a cutting device 40, and the resulting plates are stacked at 42. FIG. 3 shows an example of a cutting pattern whereby the sheet 36 under the cutting station is cut into nine individual plates 44a, 44b, 44c, . . . , 441 of standard size. As noted previously, non-standard size plates can be stacked and trimmed by one or more guillotine blades in a known manner.

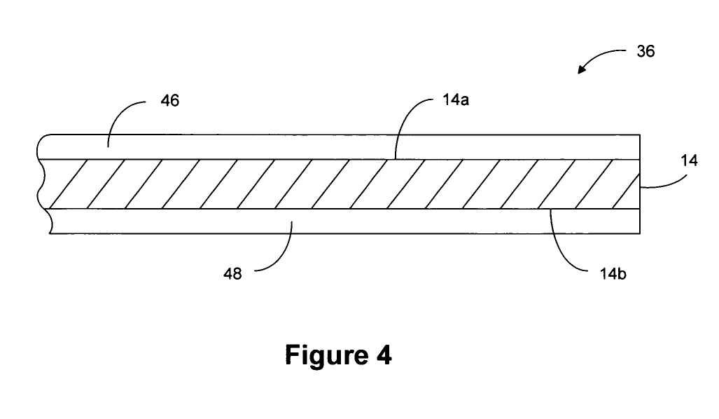

The sheet 36 and each cut plate have a cross section as shown in FIG. 4 which for convenience omits any topcoat. The metal, e.g., aluminum, substrate is in the range of about 6-12 mils thick, the imageable coating 46 has a thickness in the range of about 2 to 4 microns and is adhered to the top side 14a of the substrate, and the interleaf film has a thickness in the range of about 0.5 to 2.0 mils and is permanently adhered to the bottom side 14b of the substrate.

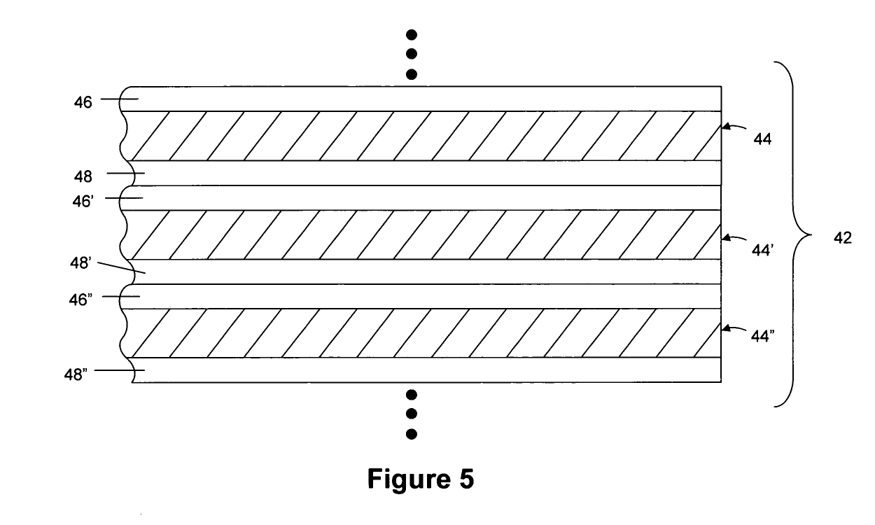

FIG. 5 is a detailed view of a plurality of stacked plates 44, 44′, 44″ as would be found in the stack 42 of FIG. 2, showing the integrated interleaf of an upper plate protecting the coating of the adjacent lower plate. For example, plate 44 has coating 46 and interleaf 48, with interleaf 48 overlying and protecting coating 46′ of the immediately adjacent plate 44′. In like manner, the interleaf 48′ of plate 44′ overlays and protects the coating 46″ on the next lower plate 44″.

It should be appreciated that in the broadest sense, the integrated interleaf can be adhered to the substrate at any point in the manufacturing line of FIGS. 1 and 2, before the cut plates are stacked at 42 in FIG. 2. If the interleaf is adhered on the substrate before the coating is cured at 20 in FIG. 1, the interleaf material must be capable of withstanding the high temperature associated with curing of the coating. If the interleaf is applied to the individual plates after cutting at 40 in FIG. 2, the advantages of scale relative to applying continuously on the full sheet, and self-lubrication, are lost.

Nevertheless, regardless of the step during manufacture at which the interleaf is applied, an individual plate having the thin integrated leaf, is believed novel and non-obvious. Moreover, a stack of such plates exhibits significant advantages in handling and imaging.

A resin or polymeric film, especially a polyolefin such as polyethylene and polypropylene, has the ideal characteristics of ready availability, low cost, known lamination equipment and procedures, high lamination adherence, insolubility in developing fluids, inks and fountain solutions, and dimensional stability at ambient temperature even when subjected to the pressures associated with a printing press.

It should also be appreciated that as used herein, a “film” of interleaf material adhered to the substrate does not require that the material was in the form of a film before adhesion to the substrate. In this context, “film” means a thin layer or layers, even if applied by coating, rolling, or processes other than heat lamination.

1. A lithographic printing plate comprising:
a thin metal substrate having top and bottom surfaces;
a radiation imageable coating covering and adhered to the top surface of the substrate; and
a polymeric interleaf film adhered to the bottom surface of the substrate;
wherein interleaf has a lesser thickness than the thickness of the substrate.

2. The printing plate of claim 1, wherein the polymeric film is laminated to the bottom surface of the substrate.

3. The printing plate of claim 1, wherein the polymeric film is a polyolefin.

4. The printing plate of claim 1, wherein the polymeric film has a thickness in the range of about 0.5-2.0 mils.

5. The printing plate of claim 1, wherein the substrate and the polymeric film have a combined thickness in the range of about 8-12 mils.

6. The printing plate of claim 1, wherein the substrate is aluminum, said top surface of the substrate is grained and anodized, said coating is imageable at a radiation wavelength within the range of ultraviolet to infra red wavelengths, and said polymeric film is heat laminated to and covers said bottom surface of the substrate.

7. The printing plate of claim 6, wherein the polymeric film is a polyolefin.

8. The printing plate of claim 7, wherein the polymeric film has a thickness in the range of about 0.5-2.0 mils.

9. The printing plate of claim 8, wherein the polymeric film is one of the group polyethylene and polypropylene.

10. A lithographic printing plate comprising:
a metal substrate having a thickness and top and bottom surfaces;
a radiation imageable coating having a thickness covering and adhered to the top surface of the substrate, and capable of development in a development fluid selected from at least one of water, fountain solution, aqueous alkaline solution, and solvent;
a film having a thickness and permanently adhered to the bottom surface of the substrate,
wherein the thickness of the film is less than the thickness of the substrate and the film is insoluble in any of said developing fluids.

11. The printing plate of claim 10, wherein the film is resinous.

12. The printing plate of claim 11, wherein the plate includes an oxygen inhibitor top coat over the imageable coating.

13. In a stack of imageable lithographic printing plates directly overlying each other, the improvement comprising that:
each plate comprises:
a flexible metal substrate having top and bottom surfaces;
a radiation imageable coating covering and adhered to the top surface of the substrate; and
a resinous interleaf film permanently adhered to the bottom surface of the substrate, wherein the interleaf has a lesser thickness than the thickness of the substrate; and
the coating of a given plate is overlaid with the interleaf film of the next higher plate in the stack.

14. The stack of printing plates of claim 13, wherein the coating is in direct contact with the interleaf film of the next higher plate in the stack.

15. The stack of printing plates of claim 13, wherein an oxygen inhibiting top coat over the imageable coating is in direct contact with the interleaf film of the next higher plate in the stack.

16. In a method for manufacturing lithographic printing plates in which an elongated sheet of a metal substrate having a top surface overlaid with a cured coating of radiation imageable material is cut into individual imageable plates, the improvement comprising that before the elongated sheet is cut into individual plates, a thin, flexible, interleaf film having a lesser thickness than the thickness of the substrate and insoluble in any of water, aqueous alkaline solution, solvent, ink, and fountain solution, is permanently adhered to and covers the bottom surface of the elongated sheet.

17. The method of claim 16, wherein the film is adhered after the elongated sheet has been coated and cured.

18. The method of claim 17, wherein the film is a polymeric material adhered by heat lamination.

19. The method of claim 18, wherein the substrate has a thickness in the range of about 6 to 12 mils, the coating has a thickness in the range of about 2 to 4 microns, and the film has a thickness in the range of about 0.5 to 2.0 mils.

20. The method of claim 18, wherein the film is a polyolefin material.

21. A method for manufacturing lithographic printing plates comprising:
selecting a wound coil of aluminum sheet, said sheet having top and bottom surfaces;
unwinding the coil and advancing the sheet through a coating station at which a liquid coating of radiation imageable material is applied to the top surface of the sheet;
curing the material to form a cured coating adhered to the top surface of the sheet;
laminating a polymeric film having a lesser thickness than the thickness of the substrate, to the bottom surface of the sheet; and
advancing the laminated sheet to a cutting device where individual plates are cut from the sheet.

22. The method of claim 21, wherein,
after lamination, the sheet is rewound, whereby in the windings of the recoil, the polymeric film is interposed between the coating on the top surface of a given winding and the bottom surface of the next winding; and
said rewound coil is unwound and the unwound sheet advanced to said cutting device.

23. The method of claim 16, wherein the film is a polyolefin material laminated by heat.

24. The method of claim 23, wherein the substrate has a thickness in the range of about 6 to 12 mils, the coating has a thickness in the range of about 2 to 4 microns, and the film has a thickness in the range of about 0.5 to 2.0 mils.

25. The method of claim 21, further including developing the plates in a developer fluid and attaching the developed plates to the cylinder of a printing press with the laminated film against the cylinder.
